(19) United States
(12) Patent Application Publication
(10) Pub. No.: US 2018/0184190 A1
(43) Pub. Date: Jun. 28, 2018

(54) PORTABLE AND MULTIFUNCTIONAL EARSET

(71) Applicant: Shenzhen Link Dream Electronic Technology Co., Ltd., Shenzhen (CN)

(72) Inventor: Hong Liu, Hunan Province (CN)

(21) Appl. No.: 15/414,308

(22) Filed: Jan. 24, 2017

(30) Foreign Application Priority Data
Dec. 26, 2016 (CN) 2016214389132

(51) Int. Cl. H04R 1/10; G01C 22/00

(52) U.S. Cl. CPC H04R 1/1041; H04R 1/1016; H04R 2420/07; H04R 1/1025; G01C 22/006; H04R 1/105

(57) ABSTRACT

Provided is a portable and multifunctional earset, comprising a main body with a shell, an arc-shaped ear hanger and an ear cap being connected to the main body, a pedometer is disposed in the main body, and one side of the main body opposite to the ear cap is a volute-shaped structure. The invention can meet a user's requirement for step counting during sport since the pedometer is disposed in the main body; the invention features beautiful appearance and convenient use, as one end of the main body exposed to the outside defines the volute-shaped structure, and the user can put the ear cap into his/her ear solely by using one finger to press the center of the volute-shaped structure.

### TECHNICAL FIELD

The invention relates to the field of earphones, and more particularly, to a portable and multifunctional earset.

### BACKGROUND

Earphones are a pair of signal conversion units that receive electric signals, and transform the signals into audible sound waves by using a speaker positioned around a user's ear. Normally the earphone is independent from a media player, and these two are connected to each other via an earphone jack. The earphone makes it possible for a user to listen to the media player alone without interfering people around him/her. In addition, the earphone can isolate environment noise, which is especially helpful for a user in a noisy environment such as a record room, a DJ, a journey, a sport area, and so on. The earphones are initially designed for use in telephones and radios, but with popularity of portable electronic devices, the earphones are widely used in mobile phones, Walkmans, radio sets, portable video games, digital audio players and so on. However, conventional earphones have comparatively simple structure, and are unsuitable for wearing.

### SUMMARY

In view of the above-mentioned problems, it is an objective of the invention to provide a portable and multifunctional earset featuring an exposed volute-shaped structure, beautiful appearance, convenient wearing, as well as a step-counting function, and thus being capable of meeting various users' requirement.

In accordance with an exemplary embodiment of the invention, provided is a portable and multifunctional earset, comprising a main body with a shell, an arc-shaped ear hanger and an ear cap being connected to the main body, a pedometer is disposed in the main body, and one side of the main body opposite to the ear cap is a volute-shaped structure.

Advantageously, a receiving groove is disposed on the shell, a function key is disposed in the receiving groove, and the function key and the shell define the volute-shaped structure.

Advantageously, the shell comprises an outer shell and an inner shell, the inner shell is covered with the outer shell, the arc-shaped ear hanger comprises a wiring shell and a shell cover, the wiring shell is covered with the shell cover, and the wiring shell and the inner shell define an integral structure.

Advantageously, a circular receiving groove is disposed on the outer shell, a spherical function key is fixed in the receiving groove, and the spherical function key is disposed in the circular receiving groove thereby forming the volute-shaped structure.

Advantageously, the main body comprises a main earphone and an auxiliary earphone, a control component is disposed in the main earphone, and a battery is disposed in the auxiliary earphone.

Advantageously, the control component comprises a Bluetooth circuit board, a tuning button, and a data interface, the function key is disposed at the rear of the volute-shaped structure, and the tuning button, the data interface and the function key are electrically connected to the Bluetooth circuit board.

Advantageously, the data interface and the tuning button are disposed on one side of the main earphone, and a dust plug is disposed on the data interface.

Advantageously, the Bluetooth circuit board comprises a sound module, a Bluetooth module and a step-counting module integrated altogether.

Advantageously, the inside of the main body defines a plane, the ear cap is disposed at an edge in the vicinity of the plane, and one side of the main body is connected to the arc-shaped ear hanger opposite to the ear cap.

Advantages of the invention are that, the invention as an earset can meet a user's requirement for step counting during sport since the pedometer is disposed in the main body; in addition, the invention features beautiful appearance and convenient use, as one end of the main body exposed to the outside defines the volute-shaped structure, and the user can put the ear cap into his/her ear solely by using one finger to press the center of the volute-shaped structure.

### BRIEF DESCRIPTION OF THE DRAWINGS

FIG. 1 is a front view of a portable and multifunctional earset of an exemplary embodiment of the invention;

FIG. 2 is a side view of a portable and multifunctional earset of an exemplary embodiment of the invention; and

FIG. 3 is an exploded view of a portable and multifunctional earset of an exemplary embodiment of the invention.

### DETAILED DESCRIPTION OF THE INVENTION

Detailed description of the invention will be given below in conjunction with accompanying drawings and specific embodiments. It should be noted that the embodiments are only meant to explain the invention, and not to limit the scope of the invention.

In the following description, it is understood that orientations or positions indicated by terms such as ‘side’, ‘inner side, ‘side edge’, ‘outer side’, ‘top’, ‘bottom’, ‘left’, ‘right’ and the like are orientations shown in the accompanying drawings or positions during use only, these terms are used for the purpose of convenient and brief description of the invention, instead of indicating or hinting that relevant means or components must have specific orientations, and be fabricated and operate in specific orientation, and therefore do not constitute a limitation on the scope of the described embodiments.

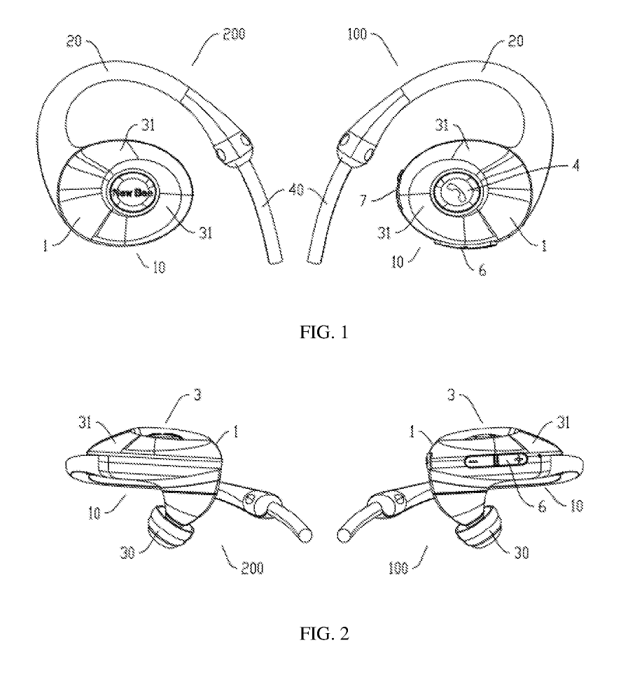

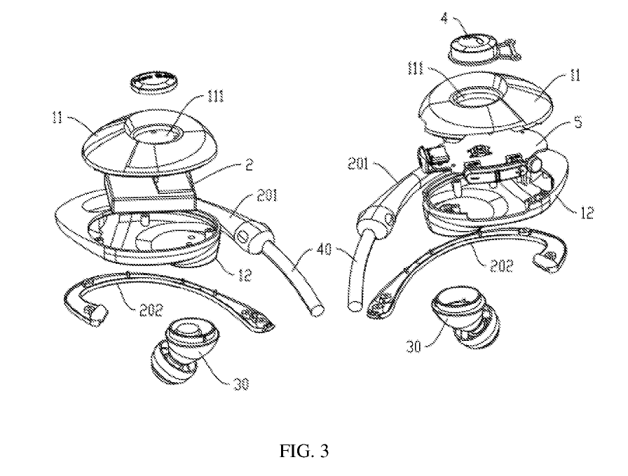

As shown in FIGS. 1 to 3, a portable and multifunctional earset of the invention comprises a main earphone 100 and an auxiliary earphone 200. Each of the main earphone 100 and the auxiliary earphone 200 comprises a main body 10 with a shell. An arc-shaped ear hanger 20 and an ear cap 30 are connected to the main body 10. The arc-shaped ear hanger 20 may be made of flexible glue, and thus features certain bending capacity and is comfortable in use. A pedometer is disposed in at least one of the earphones 100 and 200, and preferably in the main earphone 100. A battery 2 is disposed in the auxiliary earphone 200. One side of the main body 10 opposite to the ear cap 30 is a volute-shaped structure 3, and the volute-shaped structure 3 has a spiral and arc-shaped surface 31. The inside of the main body 10 defines a plane, which makes a user feel comfortable as being attached to his/her ear. The ear cap 30 is disposed at an edge in the vicinity of the plane, and one side of the main body 10 is connected to the arc-shaped ear hanger 20 opposite to the ear cap 30.

The shell 1 is a hollow cavity, and the shell 1 comprises an outer shell 11 and an inner shell 12, the inner shell 12 is covered with the outer shell 11 thereby forming the hollow cavity, the arc-shaped ear hanger 20 comprises a wiring shell 201 and a shell cover 202, the wiring shell 201 is covered with the shell cover 202, and the wiring shell 201 and the inner shell 12 define an integral structure. An earphone line 40 is received in the hollow cavity via the wiring shell 201 of the arc-shaped ear hanger 20, which makes it convenient for molding and assembling of the shell 1 and the arc-shaped ear hanger 20.

Specifically, a control component is disposed in the hollow cavity of the main earphone 100. The control component comprises a Bluetooth circuit board 5, a tuning button 6, a data interface 7, and a function key 4, the tuning button 5 and the data interface 6 are electrically connected to the Bluetooth circuit board 5, the data interface 7 and the tuning button 6 are disposed on one side of the main earphone 100, and a receiving groove 111 is disposed on the outer shell 11. The receiving groove 111 can be circular or elliptical. The function key 4 is disposed in the receiving groove 111 of the main earphone 100. As a structure fit with the receiving groove 111, the function key 4 is spherical or elliptical. The spherical or elliptical function key 4 and the shell 1 define the volute-shaped structure 3. The function key 4 is also connected to the Bluetooth circuit board 5. The spiral and arc-shaped surface 31 extends outwards from the receiving groove 111. A dust plug is disposed on the data interface 7. The Bluetooth circuit board 5 comprises a sound module, a Bluetooth module and a step-counting module integrated altogether. The step-counting module forms a pedometer, and makes it possible for a user wearing the earset to count steps during sport.

While preferred embodiments of the invention have been described above, the invention is not limited to disclosure in the embodiments and the accompanying drawings. Any changes or modifications without departing from the spirit of the invention fall within the scope of the invention.

What is claimed is:

1. A portable and multifunctional earset, comprising a main body with a shell, an arc-shaped ear hanger and an ear cap being connected to said main body, wherein
a pedometer is disposed in said main body; and
one side of said main body opposite to said ear cap is a volute-shaped structure.

2. The portable and multifunctional earset of claim 1, wherein
a receiving groove is disposed on said shell;
a function key is disposed in said receiving groove; and
said function key and said shell define said volute-shaped structure.

3. The portable and multifunctional earset of claim 1, wherein
said shell comprises an outer shell and an inner shell;
said inner shell is covered with said outer shell;
said arc-shaped ear hanger comprises a wiring shell and a shell cover;
said wiring shell is covered with said shell cover; and
said wiring shell and said inner shell define an integral structure.

4. The portable and multifunctional earset of claim 3, wherein
a circular receiving groove is disposed on said outer shell;
a spherical function key is fixed in said receiving groove; and
said spherical function key is disposed in said circular receiving groove thereby forming said volute-shaped structure.

5. The portable and multifunctional earset of claim 1, wherein
said main body comprises a main earphone and an auxiliary earphone;
a control component is disposed in said main earphone; and
a battery is disposed in said auxiliary earphone.

6. The portable and multifunctional earset of claim 5, wherein
said control component comprises a Bluetooth circuit board, a tuning button, and a data interface;
said function key is disposed at the rear of said volute-shaped structure; and
said tuning button, said data interface and said function key are electrically connected to said Bluetooth circuit board.

7. The portable and multifunctional earset of claim 6, wherein
said data interface and said tuning button are disposed on one side of said main earphone; and
a dust plug is disposed on said data interface.

8. The portable and multifunctional earset of claim 6, wherein said Bluetooth circuit board comprises a sound module, a Bluetooth module and a step-counting module integrated altogether.

9. The portable and multifunctional earset of claim 1, wherein
the inside of said main body defines a plane;
said ear cap is disposed at an edge in the vicinity of said plane; and
one side of said main body is connected to said arc-shaped ear hanger opposite to said ear cap.
